(19) United States
(12) Patent Application Publication
(10) Pub. No.: US 2023/0307975 A1
(43) Pub. Date: Sep. 28, 2023

(54) STATOR FOR AN ELECTRIC MACHINE, AND ELECTRIC MACHINE

(71) Applicant: VALEO eAutomotive Germany GMBH, Erlangen (DE)

(72) Inventor: Boris DOTZ, Bad Neustadt a.d.Saale (DE)

(73) Assignee: Valeo eAutomotive Germany GmbH, Erlangen (DE)

(21) Appl. No.: 18/041,343

(22) PCT Filed: Jul. 13, 2021
(86) PCT No.: PCT/EP2021/069489

§ 371 Date: Feb. 10, 2023

(30) Foreign Application Priority Data
Aug. 13, 2020 (DE) 10 2020 121 347.6

(51) Int. Cl. H02K 3/28; H02K 3/12; H02K 1/16

(52) U.S. Cl. CPC H02K 3/28; H02K 1/16; H02K 3/12

(57) ABSTRACT

A stator for an electric machine includes a number N ≥ 3 of phases, a number P ≥ 2 of pole pairs, a number of slots per pole and phase q ≥ 2, a stator core which has a plurality of slots formed in a circumferential direction, and a plurality of shaped conductors which are arranged in the slots in a first to fourth layer. The shaped conductors form for each phase at least two paths and are arranged in 2 × P winding zones which extend over the four layers and at least q+1 directly adjacent slots.

The present invention relates to a stator for an electric machine. In addition, the invention relates to an electric machine for driving a vehicle.

DE 20 2019 103 297 U1 discloses a stator with a stator winding arrangement structure of a drive motor, in which stator winding arrangement structure hairpin segments in the form of a hairpin are arranged, which each have two legs, which are inserted into a stator core with a plurality of slots, and in which the legs, positioned opposite to the stator core of the hairpin segments, are bent and connected in such a way that they form a circuit with a series coil bundle. A stator winding of the drive motor consists of three phases. Each of the phases of the stator winding of the drive motor is formed by means of two or more series coil bundles connected in parallel. The legs of the hairpin segments are inserted into different layers.

Stators with a stator winding formed from shaped conductors are extremely popular particularly in automotive applications since they are particularly suitable for automated manufacture with a high degree of process reliability and simple connection options for the phases. The challenge faced is that of forming the number of turns required for forming the stator winding and the desired number of paths and at the same time complying with requirements in respect of symmetry, realizing a small winding overhang and providing simple connection options for the phases. A high-quality rotating field during operation of the electric machine with small harmonics and resistive losses in the stator winding is also desirable.

The invention is therefore based on the object of specifying an improved way of operating a stator for an electric machine.

In order to achieve this object, the invention proposes a stator for an electric machine, comprising a number N ≥ 3 of phases, a number P ≥ 2 of pole pairs, a number of slots per pole and phase q ≥ 2, a stator core which has a plurality of slots formed in a circumferential direction, and a plurality of shaped conductors which are arranged in the slots in a radially layered manner in a first to fourth layer, wherein the first to fourth layer are designated in accordance with their order in a radial direction; wherein a first orientation and a second orientation, opposite to the first orientation, of the circumferential direction are defined; the shaped conductors form for each phase at least two paths, which can be connected to one another in series or in parallel, and are arranged in 2 × P winding zones which each extend radially over the four layers and in the circumferential direction over at least q+1 directly adjacent slots; wherein the shaped conductors of each path are connected in a series circuit which is implemented by connectors arranged at a first end side of the stator core and at a second end side, opposite the first end side, of the stator core; wherein each path has groups of the first type of shaped conductors connected in series and groups of the second type of shaped conductors connected in series; wherein shaped conductors of the groups of the first type are arranged over the winding zones in an alternating manner in the circumferential direction firstly in the first and fourth layer and secondly in the second and third layer; wherein shaped conductors of the groups of the second type are arranged in winding zones, in which the shaped conductors of the groups of the first type are arranged in the first and fourth layer, in the second and third layer and in winding zones, in which the shaped conductors of the groups of the first type are arranged in the second and third layer, in the first and fourth layer.

The stator according to the invention is distinguished, in particular, in that the winding zones in which the shaped conductors of the paths of a respective phase are arranged extend over at least three directly adjacent slots and the four layers, so that a spatial shift in the magnetic rotating field in the circumferential direction can be generated along an axial direction. In this way, the efficiency, the occurrence of torque ripples and the occurrence of noise and vibrations can be noticeably reduced in comparison to stators with winding zones which each extend over precisely q slots. On account of the fact that, in the stator according to the invention, the shaped conductors of the groups of the first type are arranged in a respective winding zone in the circumferential direction in an alternating manner in inner and outer layers and the shaped conductors of the groups of the second type are arranged in the correspondingly unoccupied layers, the connectors can be arranged at the first end side in an imbricated manner, as a result of which the installation space at the end sides is efficiently utilized and consequently a small winding overhang is implemented.

The number of slots per pole and phase q is the number of slots per pole and phase of the stator. With preference, q is ≤ 6, preferably q is ≤ 4, particularly preferably q is ≤ 3. In the case of the stator according to the invention, N can be ≤ 12, preferably N can be ≤ 9, particularly preferably N can be ≤ 6. Provision may be made for P to be ≤ 20, preferably for P to be ≤ 16, particularly preferably for P to be ≤ 12. The number of slots is preferably less than 200, particularly preferably less than 120. The number of slots can be precisely 2 × P × N × q. Each winding zone preferably implements one pole of the stator.

Precisely one winding zone of the other phases is expediently located between each pair of adjacent winding zones of a phase in each case. In other words, each pair of adjacent winding zones of a phase is spaced apart by q × (N-1) slots.

In a preferred refinement, provision is made for precisely four shaped conductors to be received in each slot and/or for N to be precisely 3 and/or for P to be precisely 4 and/or for q to be precisely 2. The first layer is preferably the radially outermost layer and/or the fourth layer is preferably the radially innermost layer.

The shaped conductors can be rod-like conductors, in particular composed of copper. The shaped conductors are typically not flexible. Four shaped conductors in the four layers and/or in the entire slot preferably take up at least 60%, preferably at least 80%, of the cross-sectional area of a slot. The shaped conductors preferably have a, possibly also rounded, rectangular cross section. Each shaped conductor can extend through one of the slots completely in the axial direction.

A “path” is intended to be understood to mean a series circuit of shaped conductors implemented by the connectors, which series circuit can also be referred to as a “current path”. Each path preferably comprises P groups of the first type connected in series and/or P groups of the second type connected in series. Therefore, complete encircling in the circumferential direction around the stator core can be formed by the groups of the first type or the groups of the second type. The shaped conductors of the groups of the first type and the groups of the second type of a respective path preferably occupy each winding zone of the phase at least once.

The stator core can be formed by a large number of permanently connected individual laminations layered with one another. In particular, the stator core forms a laminated core. Each slot preferably extends parallel to a centre axis along which a receiving space, surrounded by the stator core, for a rotor extends. The first orientation preferably corresponds to the clockwise direction, as seen from the first end side.

In an advantageous development of the stator according to the invention, provision can be made for the shaped conductors of a respective group of the first type to be a first shaped conductor on the outside with respect to the series circuit, a second shaped conductor directly connected to the first shaped conductor with respect to the series circuit, a third shaped conductor directly connected to the second shaped conductor with respect to the series circuit and a fourth shaped conductor directly connected to the third shaped conductor with respect to the series circuit, and for the first shaped conductor of the group of the first type to be arranged in the first layer of a first winding zone for the group of the first type, for the second shaped conductor of the group of the first type to be arranged in the second layer of a second winding zone, adjacent to the first winding zone for the group of the first type along the first orientation, for the group of the first type, for the third shaped conductor of the group of the first type to be arranged in the fourth layer of the first winding zone for the group of the first type and for the fourth shaped conductor of the group of the first type to be arranged in the third layer of the second winding zone for the group of the first type. In other words, the shaped conductors of a respective group of the first type and the connectors connecting them form a conductor loop.

The first winding zone for such groups of the first type, which are directly connected to the fourth shaped conductor of another group of the first type with respect to the series circuit, is preferably adjacent to the second winding zone for the other group of the first type along the first orientation. Consequently, the groups of the first type extend around the stator along the first orientation. As a result, winding progress along the first orientation by in each case one winding zone from a group of the first type to the next group of the first type with respect to the series circuit is implemented.

Furthermore, in an advantageous development of the stator according to the invention, provision can be made for the shaped conductors of a respective group of the second type to be a first shaped conductor on the outside with respect to the series circuit, a second shaped conductor directly connected to the first shaped conductor with respect to the series circuit, a third shaped conductor directly connected to the second shaped conductor with respect to the series circuit and a fourth shaped conductor directly connected to the third shaped conductor with respect to the series circuit, and for the first shaped conductor of the group of the second type to be arranged in the second layer of a first winding zone for the group of the second type, for the second shaped conductor of the group of the second type to be arranged in the first layer of a second winding zone, adjacent to the first winding zone for the group of the second type along the second orientation, for the group of the second type, for the third shaped conductor of the group of the second type to be arranged in the third layer of a third winding zone, adjacent to the second winding zone for the group of the second type along the second orientation, for the group of the second type and for the fourth shaped conductor of the group of the second type to be arranged in the fourth layer of a fourth winding zone, adjacent to the third winding zone for the group of the second type along the second orientation, for the group of the second type.

The first shaped conductor of such groups of the second type, which first shaped conductor is directly connected to the fourth shaped conductor of another group of the second type with respect to the series circuit, is preferably arranged in the third winding zone for the other group of the second type. Consequently, the groups of the first type extend around the stator along the second orientation. The groups of the second type combined form a wave winding and a half-loop.

Provision is preferably made for the shaped conductor, on the outside with respect to the series circuit, of the group of the second type, which shaped conductor is directly connected to the shaped conductor, on the outside with respect to the series circuit, of a first group with respect to the series circuit, to be arranged in a winding zone which, along the first orientation, is adjacent to the winding zone in which the outer shaped conductor of the first group is located. Here, the shaped conductors, connected to one another, of the group of the first type and the group of the second type can be connected by a connector which merely implements an offset by one layer. In particular, winding progress in the opposite direction to the groups of the first type can be achieved in this way.

According to an advantageous first embodiment of the stator according to the invention, provision is made for each winding zone to extend over precisely q+2 slots. This allows the formation of a staggered stator with at least two, preferably precisely two, offsets within a respective winding zone.

In this case, it is preferred when the second and third layer of a respective winding zone are located in the same slots, wherein the first layer of the winding zone is offset in relation to the second and third layer by one slot along the second orientation of the circumferential direction and the fourth layer is offset in relation to the second and third layer by one slot along the first orientation. This particularly advantageously forms staggering of the stator with excellent slot throughflow in the case of which a substantially equal material requirement for forming the shaped conductors and connectors compared to a non-staggered stator, that is to say such a stator with winding zones extending over precisely q slots, is required at the same time. In addition, in particular in the case of the above-described arrangement of the groups of a first and second type, a compact connection window can also be realized because the outer shaped conductors of a respective path move close to one another.

As an alternative, it is also possible in the case of the first embodiment for the first layer of the winding zone to be offset in relation to the second and third layer by one slot along the first orientation of the circumferential direction and for the fourth layer to be offset in relation to the second and third layer by one slot along the second orientation.

According to an advantageous second embodiment of the stator according to the invention, provision is made for each winding zone to extend over precisely q+1 slots. This allows the formation of a staggered stator with at least one, preferably precisely one, offset within a respective winding zone.

It is preferred here when the first to third layer of a respective winding zone are located in the same slots and the fourth layer of the winding zone is offset in relation to the first to third layer by one slot along the first orientation. As a result, in particular in the case of the above-described arrangement of the groups of a first and second type, two connectors shortened by one slot can be used in the circumferential direction, this reducing the material requirement in relation to a non-staggered stator and consequently reducing resistive losses. This in turn increases the efficiency of the electric machine.

As an alternative, the fourth layer of the winding zone can be offset in relation to the first to third layer by one slot along the second orientation.

In the second embodiment, provision can alternatively be made for the second to fourth layer of a respective winding zone to be located in the same slots and for the first layer of the winding zone to be offset in relation to the second and third layer by one slot along the second orientation. Particularly in the case of the above-described arrangement of the groups of a first and second type, three connectors shortened by one slot along the circumferential direction can be formed here in comparison to a non-staggered stator, as a result, of which the material requirement can likewise be reduced, as described above.

As an alternative, the first layer of the winding zone can be offset in relation to the second and third layer by one slot along the first orientation.

In a preferred development of the stator according to the invention, provision is made for each winding zone to provide 4 x q contiguous receiving spaces for one of the shaped conductors in each case and to comprise a first sub-winding zone to a q-th sub-winding zone, which sub-winding zones each extend over the four layers, wherein the first sub-winding zone, as seen from the first orientation, comprises the first receiving spaces of a respective layer and the second sub-winding zone comprises the receiving spaces directly adjoining the receiving spaces of the first sub-winding zone. The sub-winding zones are consequently a subdivision of a respective winding zone. In this case, each sub-winding zone extends over as many slots as the number of slots over which a winding zone extends differs from the number of slots per pole and phase q. Each sub-winding zone comprises precisely one receiving space per layer.

With further preference, the groups of the first type and the groups of the second type of a respective path are arranged in different sub-winding zones. Furthermore, the shaped conductors of the group of the first type can be located in the same one of the first to q-th sub-winding zone of the winding zones and the shaped conductors of the group of the second type can be located in the same one of the first to q-th sub-winding zone. As an alternative or in addition, provision can be made for the groups of the first type of different paths of the same phase to be arranged in different sub-winding zones and/or for the groups of the second type of different paths of the same phase to be arranged in different sub-winding zones. The shaped conductors of a respective path can consequently occupy those receiving spaces which the shaped conductors of the other path do not occupy.

In the case of the stator according to the invention, provision is preferably made for the shaped conductors of a respective path to be connected with respect to the series circuit in an alternating manner by connectors of the first type and second type. In this case, shaped conductors, on the outside with respect to the series circuit, of a respective path are advantageously connected to the shaped conductor next with respect to the series circuit by a connector of the second type. In particular, the outer shaped conductors can thus be contacted or connected at the end side on which the connectors of the first type are located.

In this case, the connectors of the first type can be formed in one piece with the shaped conductors connected by them and extend out of the stator core at the first end side. The connectors of the first type and the shaped conductors connected by them are preferably formed from an electrically conductive rod, wherein the connector of the first type is formed, in particular, by bending the rod.

As an alternative or in addition, provision can be made for the connectors of the second type to comprise two connecting elements which adjoin the shaped conductors, connected by the connector of the second type, at the second end side in a manner extending out of the stator core and are electrically conductively connected to one another, in particular in an integrally bonded manner. The shaped conductors and the connecting elements adjoining them can also be formed from the or an electrically conductive rod, wherein the connecting elements are formed, in particular, by bending the rod after insertion into the stator core.

A respective first connector, the shaped conductors connected by it and the connecting elements and the connecting element, adjoining the shaped conductors, of two second connectors can consequently form a one-piece conductor segment which can also be called a hairpin conductor or U-pin.

The first and the second shaped conductor of a respective group of the first type and/or the first and second shaped conductor of a respective group of the second type are preferably connected by connectors of the second type. The second and the third shaped conductor of a respective group of the first type and/or the second and the third shaped conductor of a respective group of the second type are preferably connected by connectors of the first type. The third and the fourth shaped conductor of a respective group of the first type and/or the third and the fourth shaped conductor of a respective group of the second type are preferably connected by connectors of the second type. The shaped conductors, on the outside with respect to the series circuit, of two first groups are preferably connected by connectors of the first type. The shaped conductors, on the outside with respect to the series circuit, of two second groups are preferably connected by connectors of the first type. The shaped conductor, on the outside with respect to the series circuit, of the groups of the first type of a respective path and the shaped conductor, on the outside with respect to the series circuit, of the groups of the second type of the path are preferably connected by connectors of the first type.

First connectors, which connect shaped conductors arranged in the same winding zones of different paths of the same phase and each connect shaped conductors of the same group of one of the paths, are preferably arranged in a manner imbricated with one another. They then form what is known as a U & U imbrication topology.

First connectors, which connect shaped conductors, arranged in the same winding zones, of a group of the first type with those of a group of the second type and belong to different phases of the same phase, are preferably arranged axially one in the other. They then form what is known as a U-inside-U topology. As a result, the winding overhang can be reduced further.

In the case of the stator according to the invention, it is further preferred when the shaped conductors, on the outside with respect to the series circuit and belonging to the group of the first type, of a respective path are arranged in the same winding zone and the shaped conductors, on the outside with respect to the series circuit and belonging to the group of the second type, of the path are arranged in the same winding zone, and these winding zones are adjacent. Therefore, connections for contacting the outer shaped conductors can be formed close to one another, as a result of which a particularly compact connection window is implemented.

In an advantageous development of the stator according to the invention, it further comprises a connection device which connects the shaped conductors, on the outside with respect to the series circuit and belonging to one of the groups of the first type, of the paths of a respective phase and forms a phase connection for each phase and/or connects the shaped conductors, on the outside with respect to the series circuit and belonging to one of the groups of the second type, of a respective path of a respective phase to form one or more star points. As an alternative, the stator according to the invention further comprises a connection device which connects the shaped conductors, on the outside with respect to the series circuit and belonging to one of the groups of the second type, of the paths of a respective phase and forms a phase connection for each phase and/or connects the shaped conductors, on the outside with respect to the series circuit and belonging to one of the groups of the first type, of a respective path of a respective phase to form one or more star points. The stator can be supplied with electrical power by means of such connection devices in order to form a magnetic rotating field.

At the first end side, a connection element and, at the second end side, a connecting element of a connector of the second type preferably adjoin the shaped conductors, on the outside with respect to the series circuit and belonging to the group of the first type, of a respective path and the shaped conductors, on the outside with respect to the series circuit and belonging to the group of the second type, of a respective path. Such an arrangement can also be referred to as an I-pin. The connection element preferably extends further in the axial direction than the connectors of the first type. The connection elements are preferably contacted by the connection device.

The object on which the invention is based is further achieved by an electric machine for driving a vehicle, comprising a stator according to one of the preceding claims and a rotor rotatably mounted within the stator. The electric machine is preferably an electric motor. The electric machine may be, for example, a synchronous machine with permanent excitation or a synchronous motor with permanent excitation or an asynchronous machine/induction machine or an asynchronous motor.

Further advantages and details of the present invention can be gathered from the exemplary embodiments described below and on the basis of the drawings. The drawings are schematic illustrations in which:

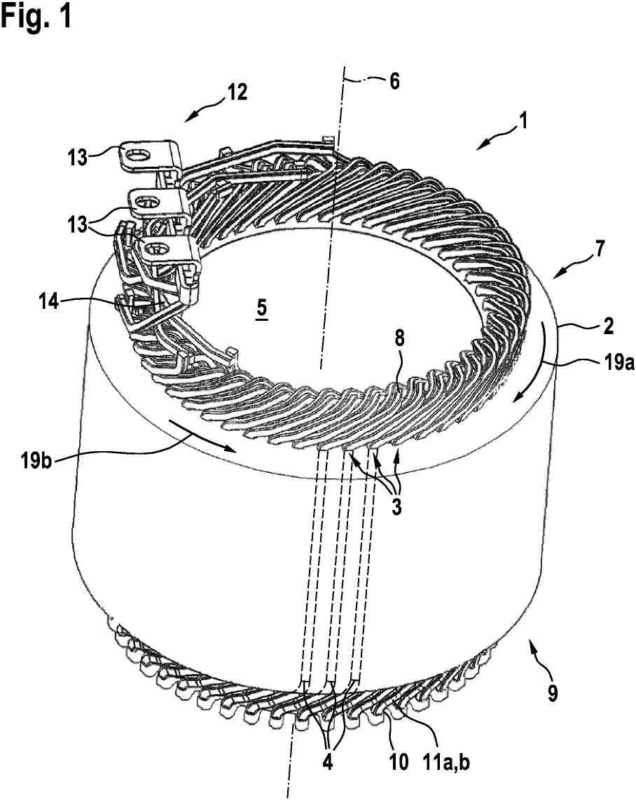

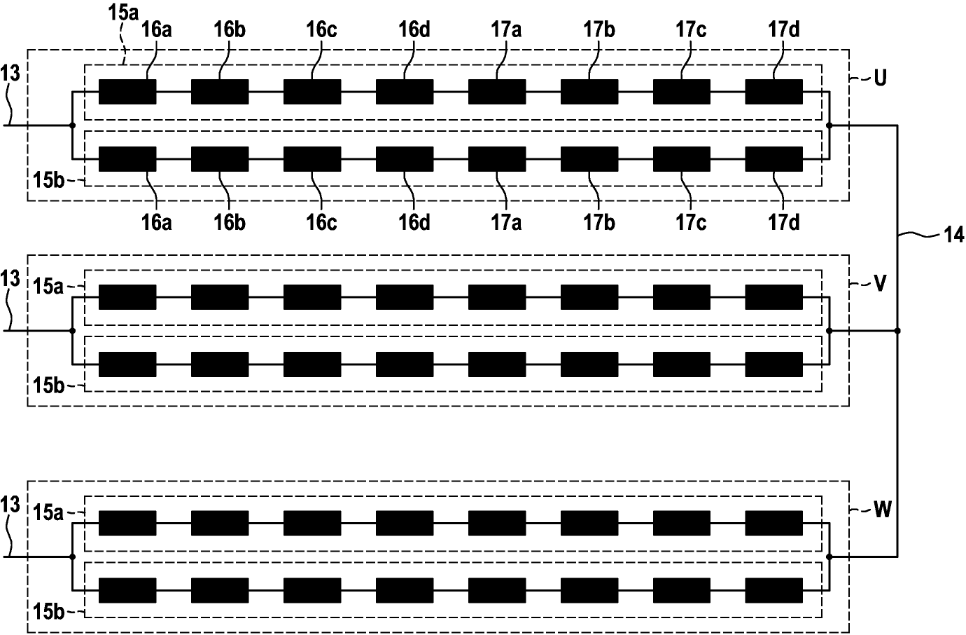

FIG. 1 shows a basic diagram of a stator;

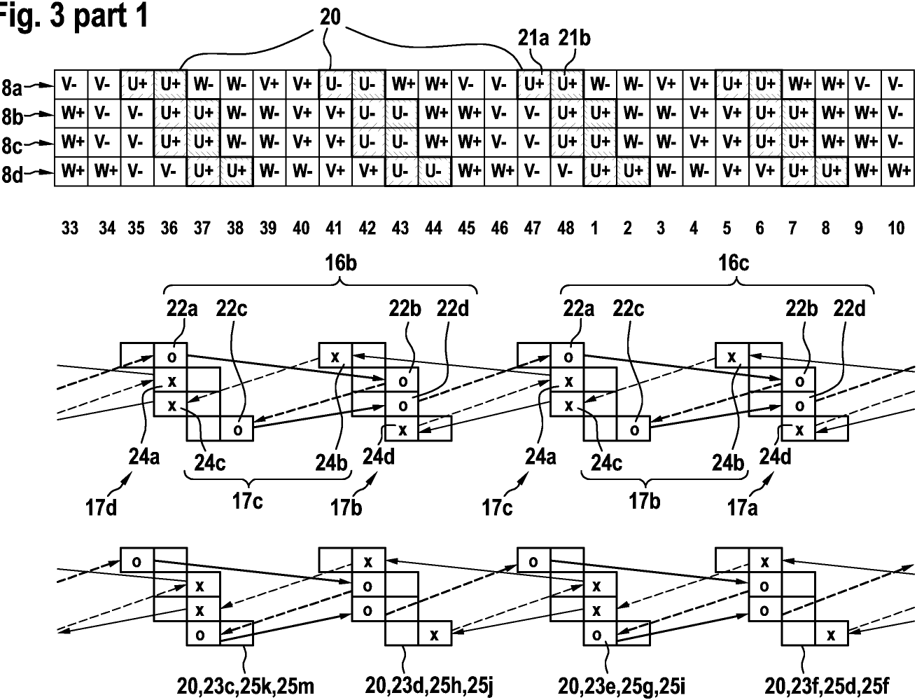

FIG. 2 shows a block circuit diagram of the stator winding of a first exemplary embodiment of the stator according to the invention;

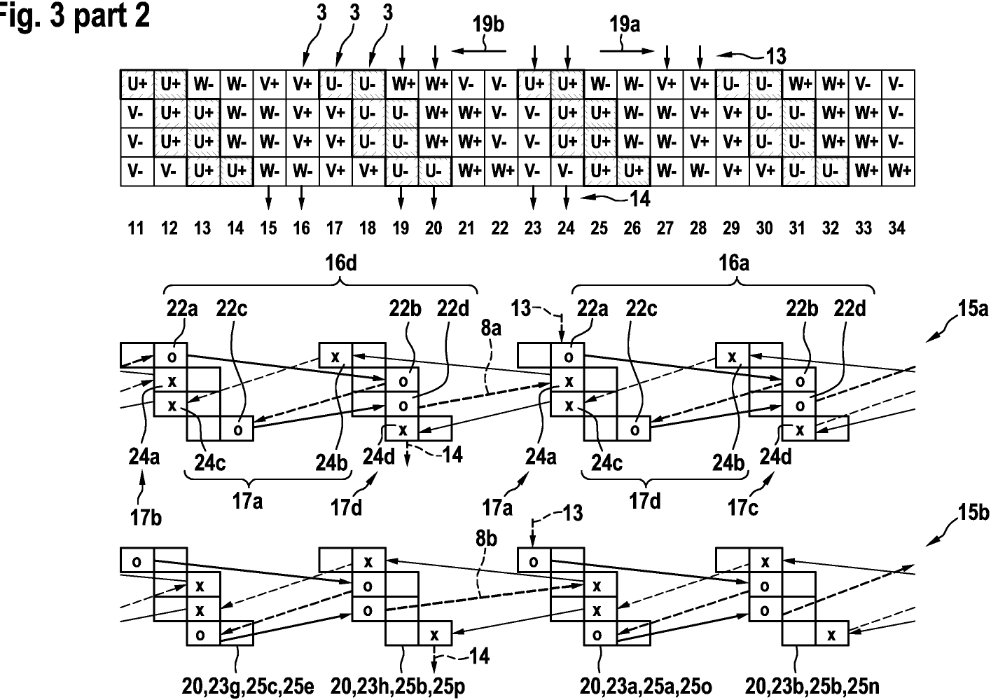

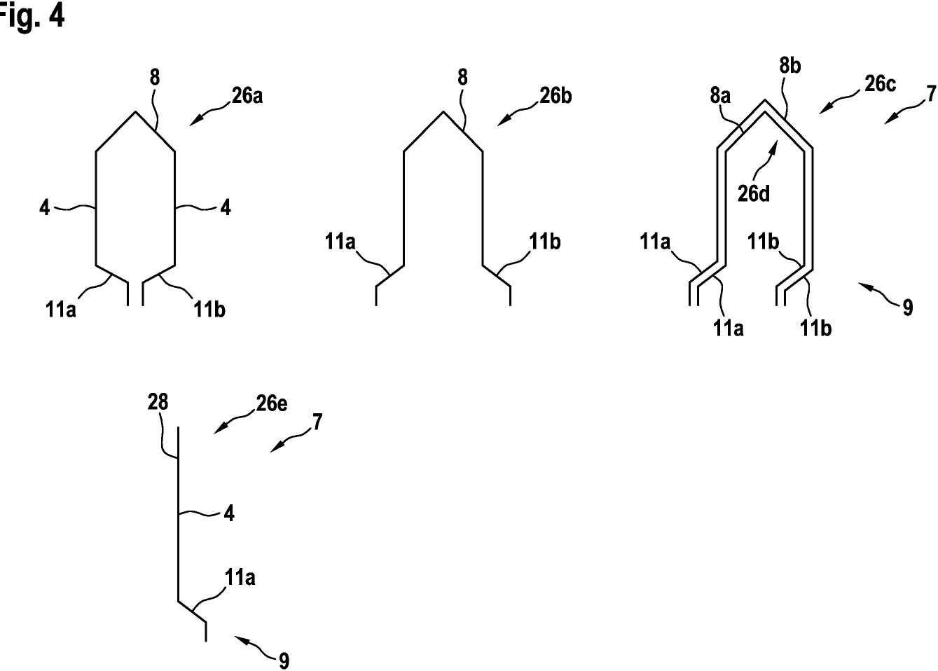

FIG. 3 shows a winding diagram according to the first exemplary embodiment;

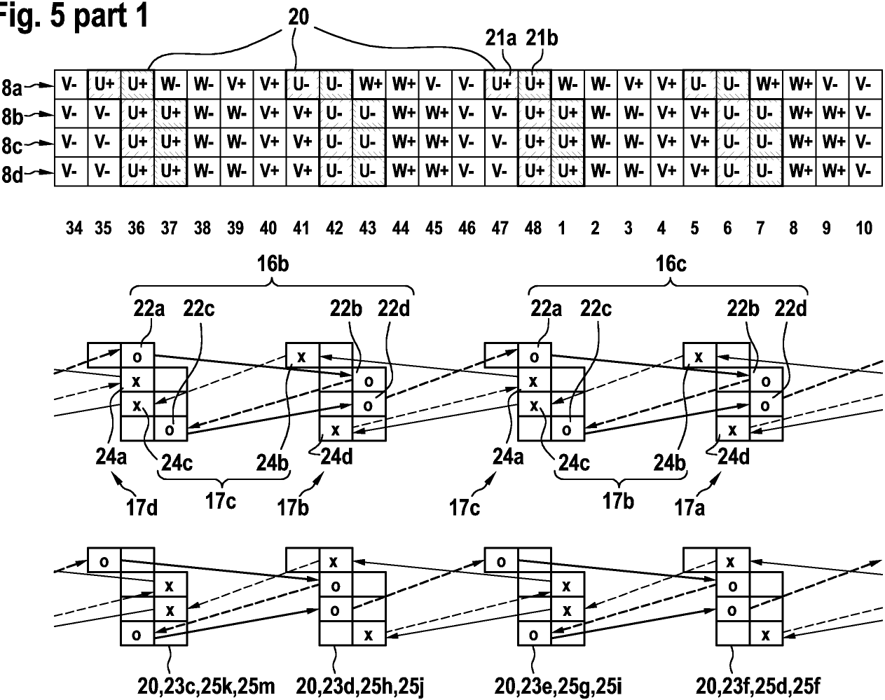

FIG. 4 shows a basic diagram of a plurality of conductor segments according to the first exemplary embodiment;

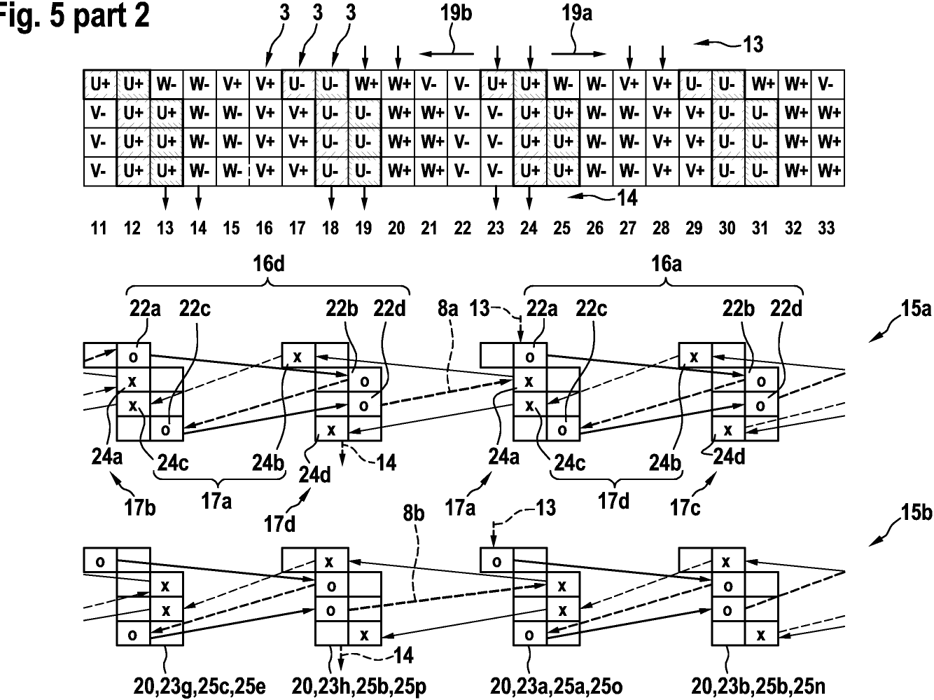

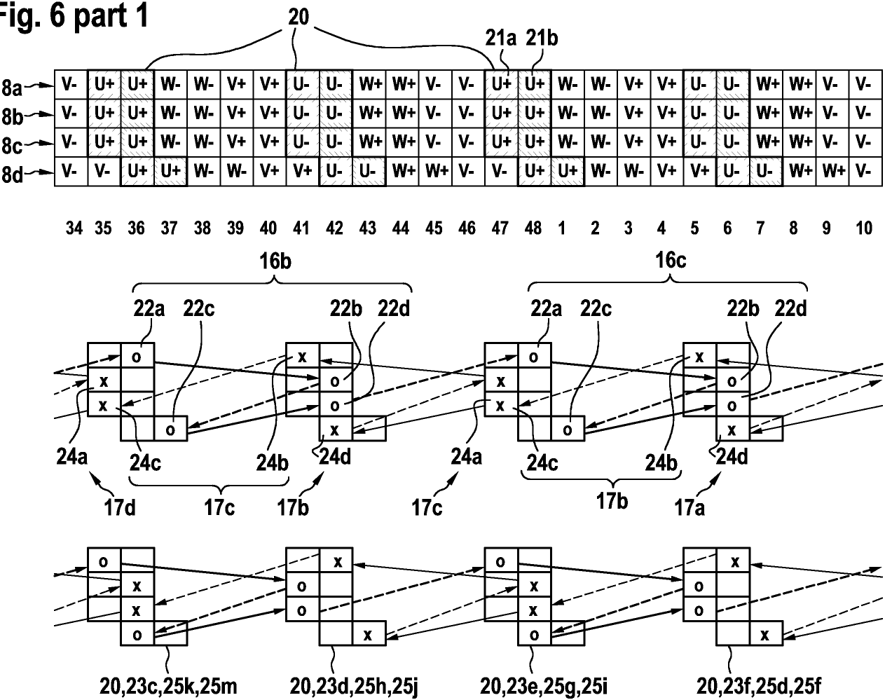

FIG. 5 shows a winding diagram according to a second exemplary embodiment of the stator according to the invention;

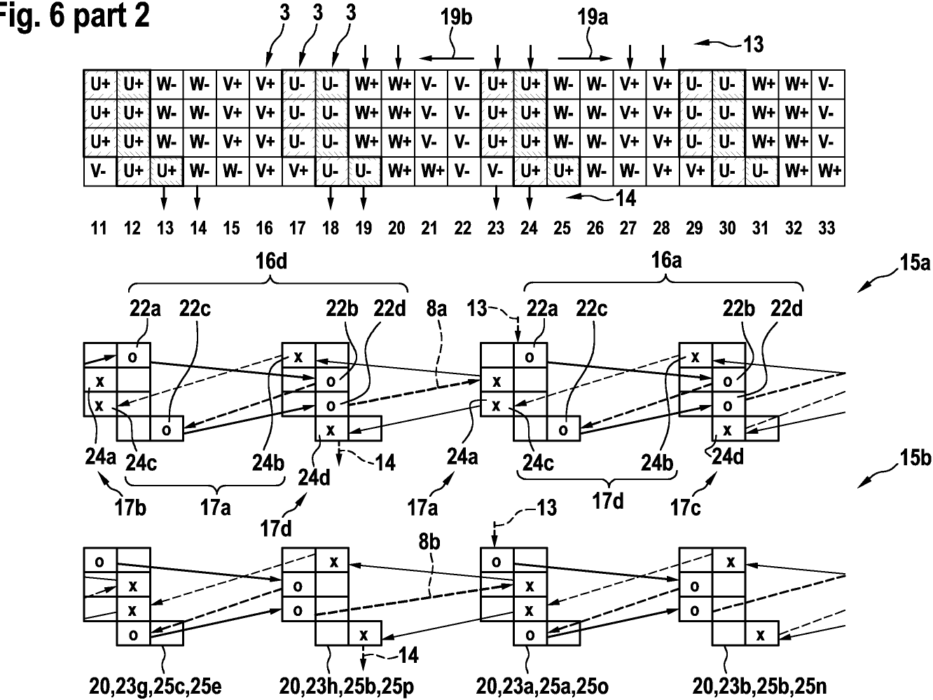

FIG. 6 shows a winding diagram according to a third exemplary embodiment of the stator according to the invention; and

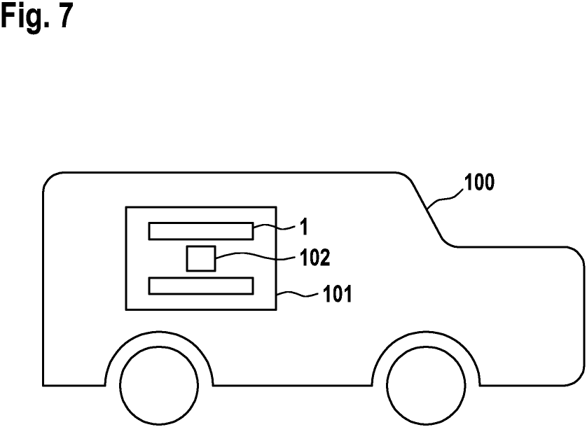

FIG. 7 shows a basic diagram of a vehicle having an exemplary embodiment of the electric machine according to the invention.

FIG. 1 is a basic diagram of a stator 1.

The stator 1 has a stator core 2 which has a large number of slots 3 formed in a circumferential direction. In addition, the stator 1 has a large number of shaped conductors 4, which are arranged in the slots 3 in a layered manner. The shaped conductors 4 extend through the slots 3 completely in the axial direction, that is to say parallel to a centre axis 6 passing through a receiving space 5 for a rotor.

At a first end side 7 of the stator 1, the shaped conductors 4 are connected in pairs by connectors of the first type 8. The connectors of the first type 8 are formed in one piece with the pair of shaped conductors 4 here and implement bending through 180°. At a second end side 9 of the stator 1, the shaped conductors 4 are connected in pairs by connectors of the second type 10. The connectors of the second type 10 comprise two bent connecting elements 11a, 11b which adjoin the connected shaped conductors 4 in one piece and are connected to one another. Here, the connection is formed in an integrally bonded manner, in particular by welding. The shaped conductors 4 and the connectors 8, 10 form a stator winding of the stator 1.

FIG. 1 further shows a connection device 12 which forms phase connections 13 and a star point 14 or a plurality of star points of the stator winding.

FIG. 2 shows a block circuit diagram of a stator winding according to a first exemplary embodiment of a stator 1, to which the statements made in relation to the stator 1 shown in FIG. 1 can be applied.

The stator 1 according to the first exemplary embodiment has, in the exemplary configuration shown, N = 3 phases U, V, W and P = 4 pole pairs. The shaped conductors 4 form a first path 15a and a second path 15b for each phase U, V, W. The paths 15a, 15b of a respective phase U, V, W are connected in parallel by means of the connection device 12. The shaped conductors 4 of a respective path 15a, 15b are connected in series.

Each path 15a, 15b comprises P = 4 groups of the first type 16a-d of shaped conductors 4 connected in series and P = 4 groups of the second type 17a-d of shaped conductors 4 connected in series. The groups of the first type 16a-d successively connected in series are connected in series to the groups of the second type 17a-d successively connected in series. The groups of the first type 16a of the paths 15a, 15b are connected to the phase connection 13 and the groups of the second type 17d of the paths 15a, 15b are connected to the star point 14 by means of the connection device 12. According to an alternative exemplary embodiment, the connection device 12 can also form two star points 14, wherein a first star point 14 connects the groups of the second type 17d of the first paths 15a of the phases U, V, W and a second star point 14 connects the groups of the second type 17d of the second paths 15b of the phases U, V, W.

FIG. 3 shows a winding diagram of the stator winding according to the first exemplary embodiment.

The stator 1 has a number of slots per pole and phase q = 2. In the present case, this results in a total number of 2 × P × N × q = 48 slots 3. The number of slots per pole and phase q therefore describes the ratio of the number of slots 3 to the product of the number of poles 2 × P and the number of phases N.

Here, the shaped conductors 4 are arranged in a first layer 18a, a second layer 18b, a third layer 18c and a fourth layer 18d, wherein the layers 18a-d are designated in accordance with their order from radially on the outside to radially on the inside. Consequently, the first layer 18a is the radially outermost layer and the fourth layer 18d is the radially innermost layer of the four layers 18a-d. Precisely one shaped conductor 4 is arranged in each layer 18a-d of a respective slot 3. In other words, each layer 18a-d of a respective slot 3 forms a receiving space for precisely one shaped conductor 4. This results in a number of, in total, 2 × P × N × q × L = 192 receiving spaces or shaped conductors 4 of the stator 1, wherein L describes the number of layers 18a-d.

FIG. 3 shows, using two arrows arranged above the upper table, a first orientation 19a of the circumferential direction, which orientation corresponds to the clockwise direction as seen from the first end side 7 of the stator 1, and a second orientation 19b, which corresponds to the anti-clockwise direction as viewed from the first end side 7 of the stator 1, (also see FIG. 1). FIG. 3 further shows slot numbering from 1 to 48 below the upper table. The upper table in FIG. 3 shows which phase U, V, W a shaped conductor 4 arranged in a respective receiving space belongs to, where the addition of a “+” or “-” denotes a direction of flow of an electric current through the shaped conductor 4 in question. It is clear that the shaped conductors of each phase U, V, W are arranged in 2 × P = 8 winding zones 20 which each comprise precisely q × L = 8 receiving spaces.

In the present exemplary embodiment, each winding zone 20 extends radially over the four layers 18a-d and in the circumferential direction over precisely q+2 = 4 directly adjacent slots 3. The winding zones 20 are, for their part, subdivided into a first sub-winding zone 21a and into a second sub-winding zone 21b which each extend over all four layers 18a-d. Here, the first sub-winding zone 21a comprises the, as seen from the first orientation 19a, first receiving spaces of the winding zone 20 and the second sub-winding zone 21b comprises the receiving spaces directly adjoining the receiving spaces of the first sub-winding zone 21a.

Below the slot numbering, FIG. 3 shows the receiving spaces, occupied by shaped conductors 4 of the phase U, in the winding zones 20, separately for the first path 15a and the second path 15b. Here, shaped conductors 4 of the groups of the first type 16a-d are identified by an “o” in their respective receiving space and shaped conductors of the groups of the second type 17a-d are identified by an “x” in their respective receiving space. Connectors of the first type 8, which connectors connect two shaped conductors 4 in two different receiving spaces, are identified by dashed arrows between the two receiving spaces, and connectors 10 of the second type, which connectors connect two shaped conductors 4 in two different receiving spaces, are identified by solid arrows between the two receiving spaces. Here, the illustration of the shaped conductors 4 and the connectors 8, 10 for the phase U is representative of the other phases V, W in which the arrangement of the shaped conductors 4 and connectors 8, 10, apart from a shift by q = 2 slots 3 in the circumferential direction, corresponds to that of phase U.

The arrangement of the shaped conductors 4 of the groups of the first type 16a-d and the groups of the second type 17a-d in the respective layers 18a-d of the winding zones 20 is configured as follows: The shaped conductors 4, identified by “o”, of the groups of the first type 16a-d are arranged over the winding zones 20 in the circumferential direction in an alternating manner firstly in the first layer 18a and the fourth layer 18d and secondly in an alternating manner in the second layer 18b and the third layer 18c. The shaped conductors, identified by “x”, of the groups of the second type 17a-d are arranged in winding zones 20, in which the shaped conductors 4 of the groups of the first type 16a-d are arranged in the first layer 18a and the fourth layer 18d, in the second layer 18b and the third layer 18c and in winding zones 20, in which the shaped conductors 4 of the groups of the first type 16a-d are arranged in the second layer 18b and the third layer 18c, in the first layer 18a and the fourth layer 18d. That is to say that either only shaped conductors 4 of the groups of the first type 16a-d or shaped conductors 4 of the groups of the second type 17a-d are arranged in the first layer 18a and the fourth layer 18d of a respective winding zone 20 and only shaped conductors 4 of the correspondingly other groups 17a-d or 16a-d are arranged in the second layer 18b and the third layer 18c of the respective winding zone 20.

In the first path 15a, the shaped conductors 4 of the groups of the first type 16a-d are always arranged in the second sub-winding zone 21b and the shaped conductors 4 of the groups of the second type 17a-d are always arranged in the first sub-winding zone 21a. In the second path 15b, the shaped conductors 4 of the groups of the first type 16a-d are always arranged in the first sub-winding zone 21a and the shaped conductors 4 of the groups of the second type 17a-d are always arranged in the second sub-winding zone 21b.

The shaped conductors 4 of each group of the first type 16a-d of a path 15a, 15b are a first shaped conductor 22a, a second shaped conductor 22b, a third shaped conductor 22c and a fourth shaped conductor 22d which are connected in series in the order of their designation. In a respective group of the first type 16a-d, the first shaped conductor 22a is arranged in the first layer 18a of a first winding zone 23a for the respective group of the first type 16a-d and the second shaped conductor 22b is arranged in the second layer 18b of a second winding zone 23b for the respective group of the first type 16a-d, wherein the second winding zone 23b for the respective group of the first type 16a-d is adjacent to the first winding zone 23a for the group of the first type 16a along the first orientation 19a. The third shaped conductor 22c is arranged in the fourth layer 17d of the first winding zone 23a for the respective group of the first type 16a. The fourth shaped conductor 22d is arranged in the third layer 18c of the second winding zone 23b for the respective group of the first type 16b. Consequently, the first to fourth shaped conductors 22a-d are arranged in a zigzag pattern and form a lap winding.

The first shaped conductor 22a of the group of the first type 16b, which first shaped conductor is directly connected to the fourth shaped conductor 22d of the group of the first type 16a with respect to the series circuit, is arranged in a first winding zone 23c for the group of the first type 16b. The first winding zone 23c for the group of the first type 16b is adjacent to the second winding zone 23b for the group of the first type 16a along the first orientation 19a. Accordingly, a second winding zone 23d is provided for the group of the first type 16b, a first winding zone 24d and a second winding zone 23e are provided for the group of the first type 16c and a first winding zone 23f and a second winding zone 23g are provided for the group of the first type 16d. In general, the first shaped conductor 22a of such groups of the first type 16b-d, which first shaped conductor is directly connected to the fourth shaped conductor 22d of another group of the first type 16a-c with respect to the series circuit, is arranged in a first winding zone 23c, 23e, 23g which is adjacent to the second winding zone 23b, 23d, 23f for the other group of the first type 16a-e along the first orientation 19a.

Therefore, the groups of the first type 16a-d, starting from the first shaped conductor 22a of the first group of the first type 16a, which shaped conductor is connected to the phase connection 13, up to the fourth shaped conductor 22d of the group of the first type 16d, form complete encircling along the first orientation 19a around the stator core 2.

The shaped conductors 4 of each group of the second type 17a-d of a path 15a, 15b are a first shaped conductor 24a, a second shaped conductor 24b, a third shaped conductor 24c and a fourth shaped conductor 24d which are connected in series in the order of their designation. In a respective group of the second type 17a-d, the first shaped conductor 24a is arranged in the second layer 18b of a first winding zone 25a, 25e, 25i, 25m for the respective group of the second type 17a-d and the second shaped conductor 24b is arranged in a second winding zone 25b, 25f, 25j, 25n for the respective group of the second type 17a-d, wherein the second winding zone 25b, 25f, 25j, 25n for the respective group of the second type 17a-d is adjacent to the first winding zone 25a, 25e, 25i, 25m for the respective group of the second type 17a-d along the second orientation 19b. The third shaped conductor 24c is arranged in a third winding zone 25c, 25g, 25k, 25o for the respective group of the second type 17a-d, wherein the third winding zone 25c, 25g, 25k, 25o for the respective group of the second type 17a-d is adjacent to the second winding zone 25b, 25f, 25j, 25n for the respective group of the second type 17a-d along the second orientation 19b. The fourth shaped conductor 24d is arranged in a fourth winding zone 25d, 25h, 25l, 25p for the respective group of the second type 17a-d, wherein the fourth winding zone 25d, 25h, 25l, 25p for the respective group of the second type 17a-d is adjacent to the third winding zone 25c, 25g, 25k, 25o for the group of the second type 17a-d along the second orientation 19b.

The first shaped conductor 24a of the second group of the second type 17b, which first shaped conductor is directly connected to the fourth shaped conductor 24d of the first group of the second type 17a with respect to the series circuit, is arranged in the first winding zone 25e for the second group of the second type 17b. Consequently, the first winding zone 25e for the second group of the second type 17b is the same winding zone 20 as the third winding zone 25c for the first group of the second type 17a etc. In general, the first shaped conductor 24a of such groups of the second type 17b-d, which first shaped conductor is directly connected to the fourth shaped conductor 24d of another group of the second type 17a-c with respect to the series circuit, is arranged in the third winding zone 25c, 25g, 25k for the other group of the second type 17a-c.

Each group of a second type 17a-d therefore forms a winding advancing in the second orientation 19b and having a half-loop. The fourth shaped conductor 24d of the fourth group of the second type 17d is connected to the star point 14.

Overall, in a respective phase U, V, W for both paths 15a, 15b,
the first winding zone 23a of the first group of the first type 16a, the first winding zone 25a of the first group of the second type 17a and the third winding zone 25o of the fourth group of the second type 17d are identical,
the second winding zone 23b of the first group of the first type 16a, the fourth winding zone 25l of the third group of the second type 17c and the second winding zone 25n of the fourth group of the second type 17d are identical,
the first winding zone 23c of the second group of the first type 16b, the third winding zone 25k of the third group of the second type 17c and the first winding zone 25m of the fourth group of the second type 17d are identical,
the second winding zone 23d of the second group of the first type 16b, the fourth winding zone 25h of the second group of the second type 17b and the second winding zone 25j of the third group of the second type 17c are identical,
the first winding zone 23e of the third group of the first type 16c, the third winding zone 25g of the second group of the second type 17b and the first winding zone 25i of the third group of the second type 17c are identical,
the second winding zone 23f of the third group of the first type 16c, the fourth winding zone 25d of the first group of the second type 17a and the second winding zone 25f of the second group of the second type 17b are identical,
the first winding zone 23g of the fourth group of the first type 16d, the third winding zone 25c of the first group of the second type 17a and the first winding zone 25e of the second group of the second type 17b are identical and
the second winding zone 23h of the fourth group of the first type 16d, the second winding zone 25b of the first group of the second type 17a and the fourth winding zone 25p of the fourth group of the second type 17d are identical.

In order to connect the groups of the first type 16a-d to the groups of the second type 17a-d in a respective path 15a, 15b, the shaped conductor 24a, on the outside with respect to the series circuit, of the groups of the second type 17a-d, that is to say the first shaped conductor 24a of the first group of the second type 17a in the winding zone 25a, is connected to the shaped conductor 22d, on the outside with respect to the series circuit, of the groups of the first type 16a-d, that is to say the fourth shaped conductor 22d of the fourth group of the first type 16d in the winding zone 23h. The winding zone 25a is adjacent to the winding zone 23h along the first orientation 19a.

As can further be seen in FIG. 3, each winding zone 20 extends over precisely q+2 = 4 slots 3. Here, the first layer 18a is offset in relation to the second and third layer 18b, 18c along the second orientation 19b by one slot 3 and the fourth layer 18d is offset in relation to the second and third layer 18b, 18c by one slot 3 along the first orientation 19a.

With such a configuration, the connectors of the first type 8 that connect the second shaped conductor 22b and the third shaped conductor 22c of a respective group of the first type 16a-d, the connectors of the first type 8 that connect the fourth shaped conductor 22d of the groups of the first type 16a-c and the first shaped conductors 22a of a group of the first type 16b-d following with respect to the series circuit, the connectors of the first type 8 that connect the second shaped conductor 24b and the third shaped conductor 24c of a respective group of the second type 17a-d and the connectors of the first type 8 that connect the fourth shaped conductor 24d of the groups of the second type 17a-c and the first shaped conductor 24a of a group of the second type 17b-d following with respect to the series circuit each implement an offset by five slots 3 in both paths 15a, 15b.

Furthermore, the connectors of the second type 10 that connect the first shaped conductor 22a and the second shaped conductor 22b of a respective group of the first type 16a-d and the connectors of the second type 10 that connect the first shaped conductor 24a and the second shaped conductor 24b of a respective group of the second type 17a-d each implement an offset by seven slots 3 in both paths 15a, 15b. The connectors of the second type 10 that connect the third shaped conductor 22c and the fourth shaped conductor 22d of a respective group of the first type 16a-d and the connectors of the second type 10 that connect the third shaped conductor 24c and the fourth shaped conductor 24d of a respective group of the second type 17a-d each implement an offset by five slots 3.

In order to connect the shaped conductors 22d, 24a, on the outside with respect to the series circuit, of the fourth group of the first type 16d and the first group of the second type 17a, different connectors of the first type 8 (designated separately by reference signs 8a, 8b in FIG. 3) are provided in the paths 15a, 15b. The connector of the first type 8a implements an offset by five slots in the first path 15a. The connector of the first type 8b implements an offset by seven slots 3 in the second path 15b.

FIG. 4 is a basic diagram of a plurality of conductor segments 26a-d according to the first exemplary embodiment.

The conductor segments 26a-d are formed from two shaped conductors 4, a connector of the first type 8, 8a, 8b which adjoins the second shaped conductors 4 at the first end side 7 and connects them, and two connecting elements 11a, 11b which adjoin a respective one of the two shaped conductors 4 at the second end side 9. Here, the conductor segment 26a-d is formed in one piece by way of example, but alternatively can also be formed by joining separate components. In each case two connecting elements 11a, 11b of different conductor segments 26a-d form a connector of the second type 10.

In the conductor segment 26a, the connecting elements 11a, 11b point towards one another in opposite orientations 19a, 19b. The connected second and third shaped conductors 22b, 22c of a respective group of the first type 16a-d and the connected fourth shaped conductors 24d and first shaped conductors 24a of different groups of the second type 17a-d are formed by conductor segments 26a.

In the conductor segment 26b, the conducting elements 11a, 11b point away from one another in opposite orientations 19a, 19b. The connected fourth shaped conductors 22d and first shaped conductors 22a of different groups of the first type 16a-d and the connected second and third shaped conductors 24b, 24c of a respective group of the second type 17a-d are formed by conductor segments 26b.

In the conductor segments 26c, 26d, the connecting elements 11a, 11b have the same orientation. Here, the connector of the first type 8a of the conductor segment 26d is arranged axially within the connector of the first type 8b of the conductor segment 26c. Therefore, the connector of the first type 8a is axially shorter than the connector of the first type 8b. The conductor segment 26c forms the shaped conductor 4, on the outside with respect to the series circuit, of the groups of the first type 16a-d, which shaped conductor is connected to the shaped conductor 4, on the outside with respect to the series circuit, of the groups of the second type 17a-d, that is to say here the fourth shaped conductor 22d of the fourth group of the first type 16d and the first shaped conductor 24a of the first group of the second type 17a of the second path 15b. The conductor segment 26d forms the shaped conductor 4, on the outside with respect to the series circuit, of the groups of the first type 16a-d, which shaped conductor is connected to the shaped conductor 4, on the outside with respect to the series circuit, of the groups of the second type 17a-d, that is to say here the fourth shaped conductor 22d of the fourth group of the first type 16d and the first shaped conductor 24a of the first group of the second type 17a of the first path 15a.

The conductor segment 26e comprises a shaped conductor 4, a connecting element 11a adjoining the shaped conductor 4 at the second end side 9 and a connection element 28 for making contact with the connection device 12 (see FIG. 1). The shaped conductors 4, on the outside with respect to the series circuit, of a respective path 15a, 15b, that is to say here the first shaped conductor 22a of the first groups of the first type 16a and a fourth shaped conductor 24d of the fourth group of the second type 17d, are formed by conductor segments 26e.

FIG. 4 schematically shows the conductor segments 26a-e, in particular without precise illustration of the number of slots 3 by which the connectors of the first type 10, 10a, 10b or the connecting elements 11a, 11b implement an offset. The conductor segments 26a-d can also be regarded as U-pins or hairpin conductors and the conductor segments 26e can be regarded as I-pins. The entire stator winding is then also referred to as a hairpin winding.

According to an alternative exemplary embodiment, the first layer 18a is offset in relation to the second and third layer 18b, 18c along the first orientation 19a by one slot 3 and the fourth layer 18d is offset in relation to the second and third layer 18b, 18c by one slot 3 along the second orientation 19b, with the offsets implemented by the connectors of the first and second type 8, 10 then changing in a corresponding manner.

FIG. 5 is a winding diagram according to a second exemplary embodiment of a stator 1. Provided nothing to the contrary is described hereinafter, all embodiments pertaining to the first exemplary embodiment can be applied to the second exemplary embodiment. Here, identical or functionally equivalent components are provided with identical reference signs.

In the second exemplary embodiment, each winding zone 20 extends over precisely q+1 = 4 slots 3. Here, the first layer 18a is offset in relation to the second to fourth layer 18b-d along the second orientation 19b by one slot 3.

With such a configuration, the connectors of the first type 8 that connect the second shaped conductor 22b and the third shaped conductor 22c of a respective group of the first type 16a-d and the connectors of the first type 8 that connect the fourth shaped conductor 24d of the groups of the second type 17a-c and the first shaped conductor 24a of a group of the second type 17b-d following with respect to the series circuit each implement an offset by six slots 3 in both paths 15a, 15b. The connectors of the first type 8 that connect the fourth shaped conductor 22d of the groups of the first type 16a-c and the first shaped conductor 22a of a group of the first type 16b-d following with respect to the series circuit and the connectors of the first type 8 that connect the second shaped conductor 24b and the third shaped conductor 24c of a respective group of the second type 17a-d each implement an offset by five slots 3.

Furthermore, the connectors of the second type 10 that connect the first shaped conductor 22a and the second shaped conductor 22b of a respective group of the first type 16a-d and the connectors of the second type 10 that connect the first shaped conductor 24a and the second shaped conductor 24b of a respective group of the second type 17a-d each implement an offset by seven slots 3 in both paths 15a, 15b. The connectors of the second type 10 that connect the third shaped conductor 22c and the fourth shaped conductor 22d of a group of the first type 16a-d and the connectors of the second type 10 that connect the third shaped conductor 24c and the fourth shaped conductor 24d of a respective group of the second type 17a-d each implement an offset by six slots 3.

According to an alternative exemplary embodiment, the first layer 18a is offset in relation to the second to fourth layer 18b-d by one slot 3 along the first orientation 19a, with the offsets implemented by the connectors of the first and second type 8, 10 then changing in a corresponding manner.

FIG. 6 is a winding diagram according to a third exemplary embodiment of a stator 1. Provided nothing to the contrary is described hereinafter, all embodiments pertaining to the second exemplary embodiment can be applied to the third exemplary embodiment. Here, identical or functionally equivalent components are provided with identical reference signs.

In the third exemplary embodiment, the fourth layer 18d is offset in relation to the first to third layer 18a-c along the first orientation 19a by one slot 3.

With such a configuration, the connectors of the first type 8 that connect the second shaped conductor 22b and the third shaped conductor 22c of a respective group of the first type 16a-d and the connectors of the first type 8 that connect the fourth shaped conductor 24d of the groups of the second type 17a-c and the first shaped conductor 24a of a group of the second type 17b-d following with respect to the series circuit each implement an offset by five slots 3 in both paths 15a, 15b. The connectors of the first type 8 that connect the fourth shaped conductor 22d of the groups of the first type 16a-c and the first shaped conductor 22a of a group of the first type 16b-d following with respect to the series circuit and the connectors of the first type 8 that connect the second shaped conductor 24b and the third shaped conductor 24c of a respective group of the second type 17a-d each implement an offset by six slots 3.

The connectors of the second type 10 that connect the first shaped conductor 22a and the second shaped conductor 22b of a respective group of the first type 16a-d and the connectors of the second type 10 that connect the first shaped conductor 24a and the second shaped conductor 24b of a respective group of the second type 17a-d each implement an offset by six slots 3 in the two paths 15a, 15b. The connectors of the second type 10 that connect the third shaped conductor 22c and the fourth shaped conductor 22d of a respective group of the first type 16a-d and the connectors of the second type 10 that connect the third shaped conductor 24c and the fourth shaped conductor 24d of a respective group of the second type 17a-d each implement an offset by five slots 3.

According to an alternative exemplary embodiment, the fourth layer 18d is offset in relation to the first to third layer 18a-c by one slot 3 along the second orientation 19b, with the offsets implemented by the connectors of the first and second type 8, 10 then changing in a corresponding manner.

FIG. 7 is a basic diagram of a vehicle 100 comprising an exemplary embodiment of an electric machine 101, for example a synchronous machine or an asynchronous machine/induction machine which is in the form of an electric motor. The electric machine 101 comprises a stator 1 according to one of the above-described exemplary embodiments and a rotor 102 which is rotatably mounted within the stator 1. In the present exemplary embodiment, the rotor 102 is permanently excited, by way of example.

1. Stator for an electric machine, comprising
a number N ≥ 3 of phases,
a number of slots per pole and phase q ≥ 2,
a stator core which has a plurality of slots formed in a circumferential direction, and
a plurality of shaped conductors which are arranged in the slots in a radially layered manner in a first to fourth layer, wherein the first to fourth layer are designated in accordance with their order in a radial direction; wherein
a first orientation and a second orientation, opposite to the first orientation, of the circumferential direction are defined; wherein
the shaped conductors form for each phase at least two paths, which can be connected to one another in series or in parallel, and are arranged in 2 x P winding zones which extend radially over the four layers each and in the circumferential direction over at least q+1 directly adjacent slots; wherein
the shaped conductors of each path are connected in a series circuit which is implemented by connectors arranged at a first end side of the stator core and at a second end side, opposite the first end side, of the stator core; wherein
each path has groups of a first type of shaped conductors connected in series and groups of a second type of shaped conductors connected in series; wherein
shaped conductors of the groups of the first type are arranged over the winding zones in the circumferential direction in an alternating manner firstly in the first and fourth layer and secondly in the second and third layer; wherein
shaped conductors of the groups of the second type are arranged in winding zones, in which the shaped conductors of the groups of the first type are arranged in the first and fourth layer, in the second and third layer and in winding zones, in which the shaped conductors of the groups of the first type are arranged in the second and third layer, in the first and fourth layer.

2. Stator according to claim 1, wherein
the shaped conductors of a respective group of the first type are a first shaped conductor on the outside with respect to the series circuit, a second shaped conductor directly connected to the first shaped conductor with respect to the series circuit, a third shaped conductor directly connected to the second shaped conductor with respect to the series circuit and a fourth shaped conductor directly connected to the third shaped conductor with respect to the series circuit, and
the first shaped conductor of the group of the first type is arranged in the first layer of a first winding zone for the group of the first type, the second shaped conductor of the group of the first type is arranged in the second layer of a second winding zone, adjacent to the first winding zone for the group of the first type along the first orientation, for the group of the first type,
the third shaped conductor of the group of the first type is arranged in the fourth layer of the first winding zone for the group of the first type and
the fourth shaped conductor of the group of the first type is arranged in the third layer of the second winding zone for the group of the first type,
wherein the first winding zone for such groups of the first type, which are directly connected to the fourth shaped conductor of another group of the first type with respect to the series circuit, is adjacent to the second winding zone for the other group of the first type along the first orientation.

3. Stator according to claim 1, wherein
the shaped conductors of a respective group of the second type are a first shaped conductor on the outside with respect to the series circuit, a second shaped conductor directly connected to the first shaped conductor with respect to the series circuit, a third shaped conductor directly connected to the second shaped conductor with respect to the series circuit and a fourth shaped conductor directly connected to the third shaped conductor with respect to the series circuit, and
the first shaped conductor of the group of the second type is arranged in the second layer of a first winding zone for the group of the second type,
the second shaped conductor of the group of the second type is arranged in the first layer of a second winding zone, adjacent to the first winding zone for the group of the second type along the second orientation, for the group of the second type,
the third shaped conductor of the group of the second type is arranged in the third layer of a third winding zone, adjacent to the second winding zone for the group of the second type along the second orientation, for the group of the second type and
the fourth shaped conductor of the group of the second type is arranged in the fourth layer of a fourth winding zone, adjacent to the third winding zone for the group of the second type along the second orientation, for the group of the second type,
wherein the first shaped conductor of such groups of the second type, which first shaped conductor is directly connected to the fourth shaped conductor of another group of the second type with respect to the series circuit, is arranged in the third winding zone for the other group of the second type.

4. Stator according to claim 2, wherein
the shaped conductor, on the outside with respect to the series circuit, of the group of the second type, which shaped conductor is directly connected to the shaped conductor, on the outside with respect to the series circuit, of a group of the first type with respect to the series circuit, is arranged in a winding zone which, along the first orientation, is adjacent to the winding zone in which the outer shaped conductor of the group of the first type is located.

5. Stator according to claim 1, wherein
each winding zone extends over precisely q+2 slots.

6. Stator according to claim 5, wherein
the second and third layer of a respective winding zone are located in the same slots, wherein
the first layer of the winding zone is offset in relation to the second and third layer by one slot along the second orientation of the circumferential direction and the fourth layer is offset in relation to the second and third layer by one slot along the first orientation or
the first layer of the winding zone is offset in relation to the second and third layer by one slot along the first orientation of the circumferential direction and the fourth layer is offset in relation to the second and third layer by one slot along the second orientation.

7. Stator according to claim 1, wherein each winding zone extends over precisely q+1 slots.

8. Stator according to claim 7, wherein
the first to third layer of a respective winding zone are located in the same slots and the fourth layer of the winding zone is offset in relation to the first to third layer by one slot along the first orientation or the second orientation or
the second to fourth layer of a respective winding zone are located in the same slots and the first layer of the winding zone is offset in relation to the second to fourth layer by one slot along the second orientation or the first orientation.

9. Stator according to claim 1, wherein
each winding zone provides 4 x q contiguous receiving spaces for one of the shaped conductors in each case and comprises a first sub-winding zone to a q-th sub-winding zone, which sub-winding zones each extend over the four layers, wherein the first sub-winding zone, as seen from the first orientation, comprises the first receiving spaces of a respective layer and the second sub-winding zone comprises the receiving spaces directly adjoining the receiving spaces of the first sub-winding zone.

10. Stator according to claim 9, wherein
the groups of the first type and the groups of the second type of a respective path are arranged in different sub-winding zones and/or
the groups of the first type of different paths of the same phase are arranged in different sub-winding zones and/or the groups of the second type of different paths of the same phase are arranged in different sub-winding zones.

11. Stator according to claim 1, wherein
the shaped conductors of a respective path are connected in an alternating manner with respect to the series circuit by connectors of the first type and second type, wherein shaped conductors, on the outside with respect to the series circuit, of a respective path are connected to the shaped conductor next with respect to the series circuit by a connector of the second type.

12. Stator according to claim 11, wherein
the connectors of the first type are formed in one piece with the shaped conductors connected by them and extend out of the stator core at the first end side and/or
the connectors of the second type comprise two connecting elements which adjoin the shaped conductors, connected by the connector of the second type, at the second end side in a manner extending out of the stator core and are electrically conductively connected to one another, in particular in an integrally bonded manner.

13. Stator according to claim 1, wherein
the shaped conductors, on the outside with respect to the series circuit and belonging to the group of the first type, of a respective path are arranged in the same winding zone and the shaped conductors, on the outside with respect to the series circuit and belonging to the group of the second type, of the path are arranged in the same winding zone, and these winding zones are adjacent.

14. Stator according to claim 1, further comprising
a connection device which
connects the shaped conductors, on the outside with respect to the series circuit and belonging to one of the groups of the first type, of the paths of a respective phase and forms a phase connection for each phase and/or connects the shaped conductors, on the outside with respect to the series circuit and belonging to one of the groups of the second type, of a respective path of a respective phase to form one or more star points or
connects the shaped conductors, on the outside with respect to the series circuit and belonging to one of the groups of the second type, of the paths of a respective phase and forms a phase connection for each phase and/or connects the shaped conductors, on the outside with respect to the series circuit and belonging to one of the groups of the first type, of a respective path of a respective phase to form one or more star points.

15. Electric machine for driving a vehicle, comprising a stator according to claim 1 and a rotor rotatably mounted within the stator.

16. Stator according to claim 2, wherein
the shaped conductors of a respective group of the second type are a first shaped conductor on the outside with respect to the series circuit, a second shaped conductor directly connected to the first shaped conductor with respect to the series circuit, a third shaped conductor directly connected to the second shaped conductor with respect to the series circuit and a fourth shaped conductor directly connected to the third shaped conductor with respect to the series circuit, and
the first shaped conductor of the group of the second type is arranged in the second layer of a first winding zone for the group of the second type,
the second shaped conductor of the group of the second type is arranged in the first layer of a second winding zone, adjacent to the first winding zone for the group of the second type along the second orientation, for the group of the second type,
the third shaped conductor of the group of the second type is arranged in the third layer of a third winding zone, adjacent to the second winding zone for the group of the second type along the second orientation, for the group of the second type and
the fourth shaped conductor of the group of the second type is arranged in the fourth layer of a fourth winding zone, adjacent to the third winding zone for the group of the second type along the second orientation, for the group of the second type,
wherein the first shaped conductor of such groups of the second type, which first shaped conductor is directly connected to the fourth shaped conductor of another group of the second type with respect to the series circuit, is arranged in the third winding zone for the other group of the second type.

17. Stator according to claim 3, wherein
the shaped conductor, on the outside with respect to the series circuit, of the group of the second type, which shaped conductor is directly connected to the shaped conductor, on the outside with respect to the series circuit, of a group of the first type with respect to the series circuit, is arranged in a winding zone which, along the first orientation, is adjacent to the winding zone in which the outer shaped conductor of the group of the first type is located.

18. Stator according to claim 2, wherein
each winding zone extends over precisely q+2 slots.

19. Stator according to claim 2, wherein
each winding zone extends over precisely q+1 slots.

20. Stator according to claim 2, wherein
each winding zone provides 4 x q contiguous receiving spaces for one of the shaped conductors in each case and comprises a first sub-winding zone to a q-th sub-winding zone, which sub-winding zones each extend over the four layers, wherein the first sub-winding zone, as seen from the first orientation, comprises the first receiving spaces of a respective layer and the second sub-winding zone comprises the receiving spaces directly adjoining the receiving spaces of the first sub-winding zone.
